(19) United States
(12) Patent Application Publication
(10) Pub. No.: US 2013/0047382 A1
(43) Pub. Date: Feb. 28, 2013

(54) Magnetic Floral Attachment Device and Method

(71) Applicant: Kyunghee C. Yim, W. Windsor, NJ (US)

(72) Inventor: Kyunghee C. Yim, W. Windsor, NJ (US)

(21) Appl. No.: 13/591,515

(22) Filed: Aug. 22, 2012

Related U.S. Application Data
(60) Provisional application No. 61/575,483, filed on Aug. 22, 2011.
(60) Provisional application No. 61/631,359, filed on Jan. 3, 2012.

(51) Int. Cl. A45F 5/08; H01F 7/02

(52) U.S. Cl. 24/5

(57) ABSTRACT

A floral attachment device, comprising, a first magnetically coupleable mounting member, a first wire extending from the first magnetically coupleable mounting member, a second wire extending from the first magnetically coupleable mounting member which is longer than the first wire, and a second magnetically coupleable mounting member wherein at least one of said first and second magnetically coupleable mounting members comprises a permanent magnet.

### CROSS REFERENCE TO RELATED APPLICATIONS

This application claims priority to U.S. Provisional Application No. 61/575,483, filed Aug. 22, 2011 and U.S. Provisional Application No. 61/631,359 filed Jan. 3, 2012 the entireties of which are incorporated herein by reference.

### FIELD OF THE INVENTION

The invention relates to a device and method for attaching a corsage or boutonniere to an article of clothing.

### BACKGROUND

It is a very old and popular tradition to wear a corsage or boutonniere for special occasions. The usual way of attaching these is with a pin. However, a pin can be difficult to attach, and can cause injury to a person or damage to a garment. To attempt to solve these problems, devices which replace the pin with a magnet have become known in the prior art. However, these devices typically require the user to provide and employ tape for attaching the device to the flowers.

The advantage of the present invention is that it is self-contained and extremely easy to use, and does not require the end user to use tape. Also, it is flexible enough to be incorporated into the corsage by a florist or manufacturer of corsages during the assembly thereof.

### SUMMARY

A floral attachment device, comprising, a first magnetically coupleable mounting member, a first wire extending from the first magnetically coupleable mounting member, a second wire extending from the first magnetically coupleable mounting member which is longer than the first wire, and a second magnetically coupleable mounting member wherein at least one of said first and second magnetically coupleable mounting members comprises a permanent magnet.

### BRIEF DESCRIPTION OF THE DRAWINGS

FIG. 1 shows a plan view of the exterior of an embodiment of the invention.

FIG. 2 shows a plan view of the interior of an embodiment of the invention.

FIG. 3 shows a sectional view along plane A-A of FIG. 2.

FIGS. 4 and 5 show how the device would be attached to a corsage.

FIG. 6 shows the device and corsage attached to the garment of a user.

FIG. 7 depicts the relative positions of magnet and metal-containing mounting member before attachment to a garment.

### DETAILED DESCRIPTION

FIG. 1 shows an exterior plan view of a first magnetically coupleable mounting member 2. The purpose of this member is to attach to the corsage and to magnetically couple to a second magnetically coupleable mounting member which will be located behind the garment when the first member is on the front. The first mounting member may be made in a variety of shapes. The embodiment depicted is in the shape of a leaf 20, and is flat so that it lies neatly on the garment.

The first mounting member has a first wire 3 and a second wire 4 which is longer than the first wire extending therefrom. Wire 3 serves as a support wire and is abutted against the flower stems when the device is attached, while wire 4 is an attachment wire which is wrapped around wire 3 and the stems to secure the attachment. Wires 3 and 4 extend from the device in generally the same direction.

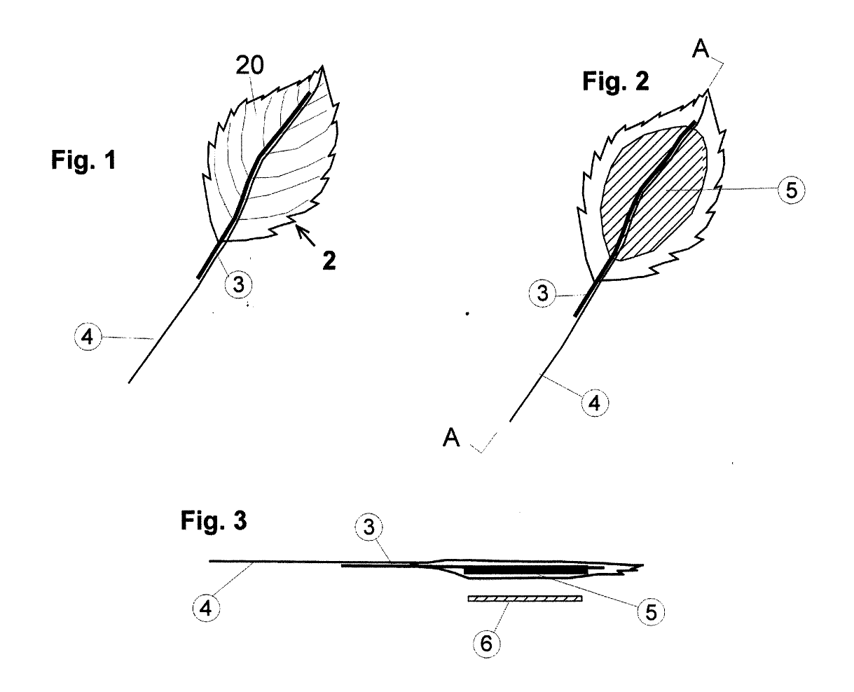

FIGS. 2 and 3 show the interior of the first mounting member, wherein there is disposed metallic element 5. Element 6, which is disposed on the other side of the garment is a permanent magnet such as a “button magnet”, although in a different embodiment the magnet could be inside the first mounting member while the metallic element would be mounted on the other side of the garment, or both mounting members could comprise permanent magnets. The metallic element should be of high enough magnetic permeability to form a strong attraction to the permanent magnet which is used, and can for example be made of steel, iron or other suitable metals. The first mounting member may be made of various different materials, for example plastic, rubber, paper, silk, fabric, metal, model magic, and the metallic element can be secured by being glued inside the member, or the member can be molded around it. Alternatively, the metallic element can be glued to the back of the member and covered with materials such as fabric or plastic. The wires 3 and 4 are fixed in the first mounting member in a similar manner, and for example may be glued to the metallic element as shown in FIG. 2. The wires 3 and 4 emerge from the device side by side as shown in the plan view of FIG. 2.

Metallic wire 3 should be thick and stiff enough to serve as a support, and by way of non-limitative example can be at least as thick as a 22 gauge wire (American Gauge System). Wire 4 should be flexible enough to wrap around wire 3 and the flower stems, and normally would be thinner than wire 3. The wires can be made of a variety of different metals, and can be solid or braided.

Wire 3 should be long enough to provide the necessary support. By way of non-limitative example, it has been found that a length of about one inch beyond the first mounting member is suitable to provide effective support for most corsages. Wire 4 should be longer, again to provide effective attachment when wrapped around the bundle of stems and wire 3. It is also advantageous to wrap wire 4 around a portion of the stems which may extend beyond wire 3. It has been found that a length of wire 4 which extends from five to six inches from the edge of the first coupling member should accommodate a bundle of corsage stems up to one inch in diameter.

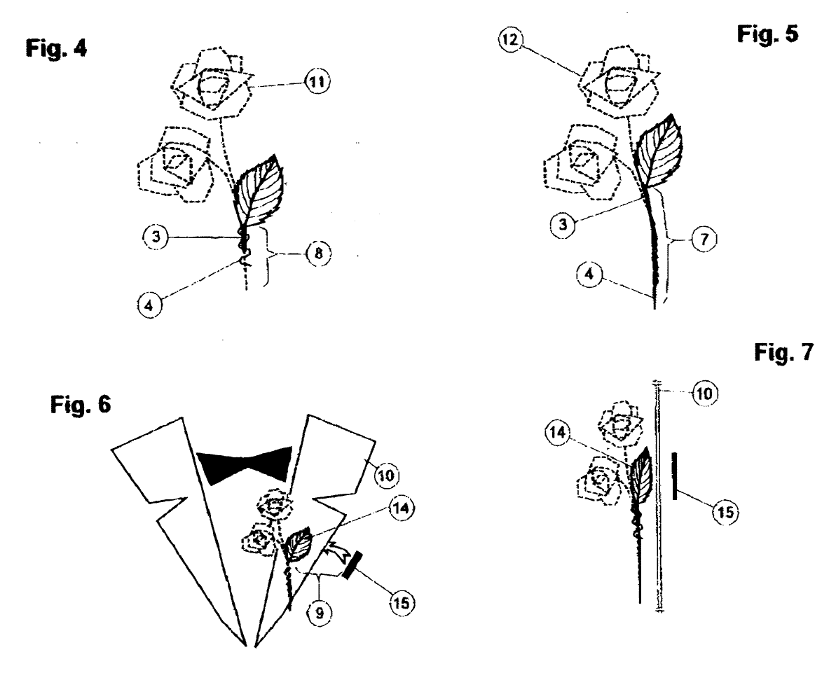

FIG. 4 depicts how the first mounting member is secured to a corsage 11 in accordance with a first method aspect of the invention. The corsage has a stem bundle 8, and wire 3 is abutted against bundle 8 so it lies in generally the same direction as the bundle. Wire 4 is then wrapped around the bundle and wire 3, and also around the bundle below wire 3. Attachment to a boutonniere would be similar. A boutonniere may have one stem or a plurality of stems.

FIG. 5 shows how a device 13 would be attached to a corsage 12 during the assembly or manufacture thereof in accordance with a second method aspect of the invention. In the prior art, to assemble a corsage, the stems of the flowers are typically brought together into a bundle, which is then wrapped with tape by the florist or manufacturer. According to this method aspect of the invention, both wires 3 and 4 are inserted into the stem bundle 7 of corsage 12 before the tape is wrapped. If the wires are too long they should be cut to the length of the stems. The same device is thus flexible enough to be used by an end user without the need to use tape, or by a corsage maker in the assembly of a corsage, where tape is already being used.

FIG. 6 depicts the intended function of a device 9, i.e., mounting to jacket lapel 10. It is noted that the leaf 14 lies neatly against the lapel while the corsage is securely held thereto.

FIG. 7 shows the relative disposition of leaf 14 and magnet 15 on either side of lapel 10 before the coupling is activated by brining the first and second mounting members into close proximity.

There thus has been disclosed a simple and effective floral attachment device and methods of employing it. While the invention has been disclosed in connection with an illustrative embodiment, it should be understood that variations will occur to those skilled in the art, and the invention is covered by the following claims and equivalents.

What is claimed is:

1. A floral attachment device, comprising;
a first magnetically coupleable mounting member;
a first wire extending from the first magnetically coupleable mounting member;
a second wire extending from the first magnetically coupleable mounting member which is longer than the first wire; and
a second magnetically coupleable mounting member, wherein at least one of said first and second magnetically coupleable mounting members comprises a permanent magnet.

2. The device of claim 1 wherein said first and second wires are adjacent to each other and extend from the first magnetically coupleable mounting member in generally the same direction.

3. The device of claim 1 wherein said first wire is a support wire for a flower stem and said second wire is an attachment wire which is flexible enough to be wrapped around said first wire and said flower stem.

4. The device of claim 3 wherein the second wire is at least three times as long as the first wire.

5. The device of claim 3 wherein the first wire is at least as thick as gauge 22.

6. The device of claim 5 wherein the second wire is thinner than the first wire.

7. The device of claim 3 wherein the first magnetically coupleable mounting member is a relatively flat member.

8. The device of claim 3 wherein said second magnetically coupleable mounting member is separate from said first magnetically coupleable mounting member.

9. The device of claim 3 wherein said second magnetically coupleable mounting member comprises a permanent magnet and said first magnetically coupleable mounting member comprise a metallic element of high enough magnetic permeability to couple to said permanent magnet.

10. A floral attachment device, comprising;
a first magnetically coupleable mounting member;
a first wire extending from the first magnetically coupleable mounting member;
a second wire extending from the first magnetically coupleable mounting member which is longer than the first wire, said first and second wires being adjacent to each other and extending from the first magnetically coupleable mounting member in generally the same direction; and
a second magnetically coupleable mounting member wherein at least one of said first and second magnetically coupleable mounting members comprises a permanent magnet.

11. A floral attachment device, comprising:
a first magnetically coupleable mounting member having a first wire extending therefrom which is a support member for a flower stem,
a second wire extending from said first magnetically coupleable mounting member which is an attachment wire and is flexible enough to be wrapped around said first wire and flower stem, said second member being at least twice as long as said first wire and extending in generally the same direction as said first wire, and
a second magnetically coupleable mounting member which is separate from said first magnetically coupleable mounting member and comprises a permanent magnet,
wherein at least one of said first and second magnetically coupleable mounting member comprises a permanent magnet.

12. The device of claim 11 wherein the first wire is at least as thick as gauge 22.

13. The device of claim 12 wherein the second wire is thinner than the first wire.

14. A method of attaching the floral attachment device of claim 3 to at least one stem of a boutonniere or corsage, comprising the steps of:
abutting the first wire against said stem, and
wrapping the second wire around both said stem and first wire.

15. The method of claim 14 wherein part of the second wire is wrapped around a portion of the stem which extends beyond the first wire.

16. A method of attaching the floral attachment device of claim 2 to a corsage comprising a plurality of flowers having stems during the assembly of the corsage, comprising the steps of:
forming a bundle of said stems,
inserting said first and second wires into said bundle of stems so that they lie in generally the same direction as said stems, and
securing said stems and wires to each other by wrapping them with tape.
